(19) United States
(12) Patent Application Publication
(10) Pub. No.: US 2008/0283628 A1
(43) Pub. Date: Nov. 20, 2008

(54) Spray Nozzle Assembly of a Window Washing System, Especially For a Windshield of a Vehicle

(75) Inventors: Matthias Beyer, Boblingen (DE); Arnaud Le Mercier, Stuttgart (DE); Markus Rathey, Bad Bellingen (DE); Daniel Utz, Bad Bellingen (DE); Peter Zielke, Adorf/V (DE)

Correspondence Address: BAKER & DANIELS LLP;111 E. WAYNE STREET, SUITE 800, FORT WAYNE, IN, 46802, US

(73) Assignees: REHAU AG & CO., Rehau (GE); A. RAYMOND & CIE, Grenoble (FR)

(21) Appl. No.: 11/577,781

(22) PCT Filed: Oct. 26, 2005
(86) PCT No.: PCT/DE05/01911

§ 371 Date: Sep. 24, 2007

(30) Foreign Application Priority Data
Oct. 30, 2004 (DE) 102004052709.1

(51) Int. Cl. B60S 1/52

(52) U.S. Cl. 239/284.1

(57) ABSTRACT

A spray nozzle assembly of a window washing system, especially for a windshield (2), of a vehicle, comprising two closely adjacent spray nozzles (4) that are in particular provided in a common spray nozzle module and are individually adjustable in terms of their spraying direction, is designed to permit optimal window cleaning with the least possible impairment of visibility during the operation of the window washing system, while affording a streamlined design for the window washing system, that is, one in which the window (2) is cluttered with as few individual elements as possible. To this end, one such spray nozzle assembly has the following features: the two spray nozzles (4) are configured as mist spraying nozzles operative to produce spray-mist fans (5, 6) whose respective apices are located in the associated spray nozzle opening; both spray nozzles (4) can be supplied with washing fluid for simultaneous spraying; and the spray-mist fans (5, 6) producible by said spray nozzles (4) are disposed at least for the most part horizontally adjacently, based on a vertical projection of the window (2) to be cleaned.

### BACKGROUND OF THE INVENTION

1. Field of the Invention

The present invention relates to a spray nozzle assembly of a window washing system, especially for a windshield, of a vehicle.

2. Description of the Related Art

One spray nozzle assembly is known from EP 0 830 996 B1. The two spray nozzles, there disposed in a common module, are alternately supplied with washing fluid from a common washing fluid supply chamber. A pendulum member oscillating in the common fluid supply chamber sets the fluid to be sprayed in oscillation and operates to deliver it in alternation to the spray nozzles adjacently disposed in the module. The nozzle heads containing the outlet openings can be adjusted to produce different spraying directions. With a spray nozzle assembly of this kind, a window wash area that is to be wetted in its entirety is wetted periodically alternately in subareas, that is, common, simultaneous wetting of the entire wash area is neither provided nor possible.

Window washing systems comprising spray nozzles that deliver the washing medium in a fan shape in misted form, i.e. in the form of very small droplets, are known from U.S. Pat. No. 5,860,603 and U.S. Pat. No. 4,463,904. In particular, the construction and manner of operation of spray-mist-producing spray nozzles are described in detail in those documents. In washing systems comprising spray nozzles of this kind, when used for example to clean a vehicle windshield, plural spray nozzles are spacedly distributed across the width of the windshield. At least one spray nozzle is provided on each half of the windshield. In one application known from practice, two mutually spaced-apart spray nozzles are disposed on the driver side of the windshield. Each of these known spray nozzles delivers a spray mist in the shape of a fan whose apex is located in the opening of an associated spray nozzle. Any region of overlap of the spray-mist fans should be as small as possible, since there is a risk of excessive buildup of fluid in an overlap area. Such areas of excessive fluid buildup have the disadvantage that visibility through the windshield is impaired too severely in these areas. Consequently, in positioning and adjusting the spraying direction of the known spray nozzles, care is taken to eliminate or at least minimize such areas of overlap having a negative effect on the transparency of the windshield. Spray-mist fan shapes are therefore selected in which the fan has the smallest possible fan angle relative to its apex. This, in turn, has the consequence that either a large number of individual, mutually adjacent spray nozzles must be deployed across the width of the windshield, or the windshield cannot be sprayed adequately, especially in the lower lateral regions.

Attempts have been made in practice to employ so-called dual spray nozzles, which deliver spray-mist fans that are located one above the other. The configuration of these fans is such that a lower fan is produced that has a relatively large fan angle and is relatively short in the heightwise direction of the windshield. The second spray-mist fan is positioned above the first, lower spray-mist fan. This second fan has a smaller fan angle than the first fan and a greater extent in the heightwise direction of the windshield than the lower spray angle. A disadvantage of this arrangement of spray-mist fans is that the second spray-mist fan extends above the first, lower spray-mist fan in the lower region of the windshield. This has the consequence that, at least when the vehicle is in motion, the spray-mist fluid from the two spray-mist fans commingles in the overlap area and thus impairs visibility. Moreover, this impairment of visibility on the driver side occurs right in the driver's main field of vision.

### SUMMARY OF THE INVENTION

The present invention is directed toward a spray nozzle assembly that enables window washing systems to wet a windshield as completely as possible, including in its outermost lateral areas, using as few spray nozzle assemblies as possible. A particular aim is to avoid any overlap of spray-mist fans generated by individual spray nozzles, to avoid impairing visibility during the operation of the window washing system.

The invention is based on the general idea of producing horizontally adjacent spray-mist fans with apices that are as close together as possible, i.e., are generated by spray nozzles that are practically directly adjacent one another. Such directly adjacent spray nozzles can be used to generate spray-mist fans in the plane of the window that are very steeply inclined relative to one other within that plane. Given such a steep relative inclination, intermediate areas of overlap of such mutually adjacent spray-mist fans can be kept to a minimum, and even virtually eliminated in the extreme case. Overlap can be virtually eliminated if the boundary lines of the sprayed areas of adjacent spray-mist fans are nearly parallel to each other. If the spray nozzles are located directly adjacent one another, when the boundary lines are parallel in this fashion, there is virtually no area of overlap and virtually no unsprayed area of the window. This would not be possible with the spaced-apart spray nozzles known from the prior art. In those cases, if neighboring boundary lines were to extend parallel to each other, an unsprayed area of window would occupy the space between two adjacent spray nozzles. With a spray nozzle assembly according to the invention, in which the spray nozzles are disposed directly adjacent one another, it becomes possible in particular to wet the lower, lateral edge regions of a windshield very satisfactorily.

In one form thereof, the present invention provides a spray nozzle assembly of a window washing system, especially for a windshield (2), of a vehicle, including two closely adjacent spray nozzles (4) that are provided in a common spray nozzle module and are individually adjustable in terms of their spraying direction, characterized by the features that, the two spray nozzles (4) are configured as mist spraying nozzles, in which the fluid to be sprayed is set in oscillation to produce spray-mist fans (5, 6), each spray-mist fan (5, 6) having a spray-mist fan (5, 6) apex in the respective associated spray nozzle opening, both of the spray nozzles (4) can be supplied with washing fluid for simultaneous spraying, and the spray-mist fans (5, 6) producible by the spray nozzles (4) are disposed at least for the most part horizontally adjacently, based on a vertical projection of the window (2) to be cleaned, for which purpose both of the spray nozzle openings of a respective spray nozzle module (3) are arranged directly adjacently, i.e., as close together as possible, and wherein moreover a spray-mist module (3) is provided on each side (11) of the windshield (2).

### BRIEF DESCRIPTION OF THE DRAWING

The above mentioned and other features and objects of this invention, and the manner of attaining them, will become more apparent and the invention itself will be better understood by reference to the following description of embodiments of the invention taken in conjunction with the accompanying drawing, wherein:

FIG. 1 is a schematic view from the front of a windshield comprising washer spray nozzles.

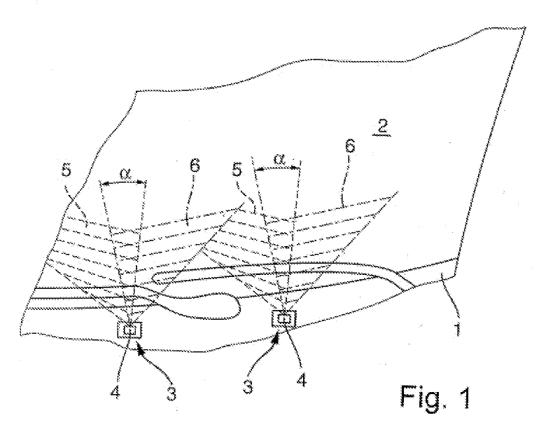

Corresponding reference characters indicate corresponding parts throughout the view. Although the exemplification set out herein illustrates an embodiment of the invention, the embodiment disclosed below is not intended to be exhaustive or to be construed as limiting the scope of the invention to the precise form disclosed.

### DETAILED DESCRIPTION

In a region 1 below a windshield 2, provided in the region of each lateral half of the windshield 2 is a spray nozzle assembly in the form of a spray nozzle module 3, each of which comprises two individually adjustable spray nozzles 4. The spray nozzles 4 are each part of a respective spray mechanism through which the spray exits, fan-like, from each of the spray nozzles 4. These spray-mist fans are respectively denoted in the drawing by reference numerals 5 and 6. Each of these spray-mist fans 5, 6 comes from an associated spray nozzle 4. The spray nozzles 4 of each pair are disposed directly adjacently, that is, as close as possible to each other, in a spray nozzle module 3.

In the exemplary embodiment shown, the spray-mist fans 5 and 6 generated by respective spray nozzles 4 disposed adjacently in a spray nozzle module 3 overlap by less than about α=15 angular degrees. In an optimized layout, this overlap area can be reduced to nearly 0 in the ideal case. This is the major advantage that can be achieved with an assembly according to the invention. This advantage is so important because areas of overlap of the spray-mist fans 5, 6 that occur when the window washing system is in operation create visual obstructions for the driver that absolutely must be prevented, particularly for reasons of driving safety.

A further major advantage achieved by means of the invention is the ability to make do with the fewest possible spray nozzle modules 3. This reduces manufacturing costs. For example, an arrangement in which one spray nozzle module 3 according to the invention is disposed in each lateral half area of a windshield 2 yields wiping results that could be achieved heretofore, if at all, only by distributing spray atomizing nozzles across the windshield 3.

The ability to adjust the spraying direction of the spray nozzles 4 in the spray nozzle modules 3 makes it possible to orient the spray-mist fans 5, 6 optimally in suitable directions for individual window geometries, particularly for an extremely wide variety of window curvatures.

Since the inventive mist spraying nozzles 4 are of a kind widely known in the prior art, specifically from the documents cited hereinabove, their construction requires no further explanation here. As to the combined presence of a pair of individual spray nozzles in each of the inventive spray nozzle modules 3, here again, this is a measure that can readily be implemented by a skilled person on the basis of the available prior art.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. (canceled)

2. A spray nozzle assembly for use in a window washing system, such as a windshield of a vehicle, said spray nozzle assembly comprising:
a spray-mist module provided on each side of a windshield, each module including two closely adjacent spray nozzles supplied with washing fluid for simultaneous spraying, the spray nozzles individually adjustable with respect to their spraying directions, and each configured as mist spraying nozzles in which washing fluid is sprayed in oscillation to produce respective spray-mist fans each having an apex in its respective associated spray nozzle opening; and
the spray-mist fans disposed substantially horizontally adjacently, based on a vertical projection of a windshield to be cleaned, and the spray nozzle openings of each module arranged directly adjacent to one another.

3. The spray nozzle assembly of claim 2, wherein the spray mist fans of each module overlap by an angle of 15 angular degrees or less.

4. The spray nozzle assembly of claim 2, wherein the spray mist fans of each module substantially do not overlap.
